(19) United States
(12) Patent Application Publication
(10) Pub. No.: US 2023/0177654 A1
(43) Pub. Date: Jun. 8, 2023

(54) METHOD OF REMOVING NOISE IN IMAGE, ELECTRICAL DEVICE, AND STORAGE MEDIUM

(71) Applicant: GUANGDONG OPPO MOBILE TELECOMMUNICATIONS CORP., LTD., Dongguan (CN)

(72) Inventor: Toshihiko ARAI, Yokohama (JP)

(21) Appl. No.: 18/147,179

(22) Filed: Dec. 28, 2022

Related U.S. Application Data
(63) Continuation of application No. PCT/CN2020/113038, filed on Sep. 2, 2020.

(51) Int. Cl. G06T 5/00; G06T 7/00

(52) U.S. Cl. CPC G06T 5/002; G06T 7/0002; G06T 2207/30168; H04N 23/81

(57) ABSTRACT

A method of removing noise in an image includes calculating, for each pixel in the image, a defect weight indicating a correlation between pixel and its neighboring pixels; calculating, for a target pixel in the image, a matching weight indicating a similarity between a target block centered on the target pixel and a reference block centered on a reference pixel located within a search range from the target pixel, the matching weight being calculated by means of the defect weight; and calculating a filtered value of the target pixel based on a value of the reference pixel and the matching weight between the target block and the reference block centered on said reference pixel.

### CROSS-REFERENCE TO RELATED APPLICATION(S)

This application is a continuation of International Application No. PCT/CN2020/113038, filed Sep. 2, 2020, the entire disclosure of which is incorporated herein by reference.

### TECHNICAL FIELD

The present disclosure relates to a method of removing noise in an image, an electrical device, and a storage medium.

### BACKGROUND

Non-Local Means (NLM) filtering is a denoising technique which is known as an advantageous method for maintaining clarity, edge and details of an image captured by a camera assembly. According to NLM filtering, a value of a target pixel is converted to a filtered value based on a similarity between the target pixel and a reference pixel located in a predetermined range from the target pixel, for example. As similarity increases, the weight of the reference pixel also increases.

When a similarity between a target block centered on the target pixel and a reference block centered on the reference pixel is considered, the similarity decreases as the difference between a pattern of the reference block and a pattern of the target block increases. In other words, a reference pixel in a reference block which differs from the target block has low weight. On the other hand, a reference pixel in a reference block similar to the target block has high weight.

However, if there is a defect pixel with extremely large value due to, for example, an initial failure of an image sensor (i.e., permanent noise) in the target block or the reference block, or if there is a strong spike noise due to, for example, heat of an electrical device (i.e., temporary noise) in the target block or the reference block, the similarity (i.e., the weight) decreases even when the reference block is similar to the target block. As a result, NLM filtering cannot be performed appropriately.

### SUMMARY

In a first aspect, a method of removing noise in an image includes:

calculating, for each pixel in the image, a defect weight indicating a correlation between pixel and its neighboring pixels;

calculating, for a target pixel in the image, a matching weight indicating a similarity between a target block centered on the target pixel and a reference block centered on a reference pixel located within a search range from the target pixel, the matching weight being calculated by means of the defect weight; and

calculating a filtered value of the target pixel based on a value of the reference pixel and the matching weight between the target block and the reference block centered on said reference pixel.

In a second aspect, an electrical device for image processing includes: a processor and a memory for storing instructions, where the instructions, when executed by the processor, cause the processor to perform the method according to the method of the first aspect.

In a third aspect, a non-transitory computer-readable storage medium is provided, on which a computer program is stored, where the computer program is executed by a computer to implement the method according to the method of the first aspect.

### BRIEF DESCRIPTION OF THE DRAWINGS

These and/or other aspects and advantages of embodiments of the present disclosure will become apparent and more readily appreciated from the following descriptions made with reference to the drawings, in which:

FIG. 1 is a plan view of a back side of an electrical device according to an embodiment of the present disclosure;

FIG. 2 is a plan view of a front side of the electrical device according to the embodiment of the present disclosure;

FIG. 3 is a block diagram of the electrical device according to the embodiment of the present disclosure;

FIG. 4 is a main flowchart of a noise removing process performed according to the embodiment of the present disclosure;

FIG. 5 is a flowchart of the first example for obtaining a defect weight;

FIG. 6 shows an interest pixel and its 8-neighbors;

FIG. 7 shows an example of a graph of a line function for converting a normalized value;

FIG. 8 is a flowchart of the second example for obtaining a defect weight;

FIG. 9 shows an example of a target block, a plurality of reference blocks and a search range;

FIG. 10 is a diagram for explaining how to calculate a matching weight between a target block and a reference block; and

FIG. 11 shows an example of a graph of a conversion function.

### DETAILED DESCRIPTION

Embodiments of the present disclosure will be described in detail and examples of the embodiments will be illustrated in the accompanying drawings. The same or similar elements and elements having same or similar functions are denoted by like reference numerals throughout the descriptions. The embodiments described herein with reference to the drawings are explanatory and aim to illustrate the present disclosure, but shall not be construed to limit the present disclosure.

<Electrical Device 10>

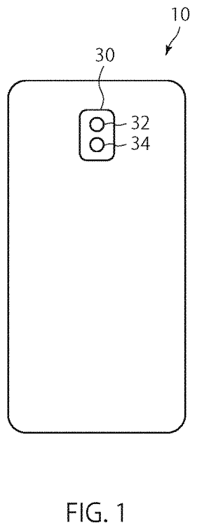

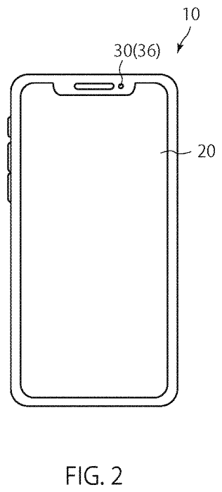

FIG. 1 illustrates a plan view of a back side of an electrical device 10 according to an embodiment of the present disclosure. FIG. 2 illustrates a plan view of a front side of the electrical device 10 according to the embodiment of the present disclosure.

As shown in FIG. 1 and FIG. 2, the electrical device 10 may include a display 20 and a camera assembly 30. In the present embodiment, the camera assembly 30 includes a first main camera 32, a second main camera 34 and a sub camera 36. The camera assembly 30 does not have a shutter which opens only when shooting an image. Alternatively, the camera assembly 30 may have the shutter.

The first main camera 32 and the second main camera 34 can capture an image in the back side of the electrical device 10 and the sub camera 36 can capture an image in the front side of the electrical device 10. Therefore, the first main camera 32 and the second main camera 34 are so-called out-cameras whereas the sub camera 36 is a so-called in-camera. As an example, the electrical device 10 can be a mobile phone, a smartphone, a tablet computer, a personal digital assistant, and so on.

Although the electrical device 10 according to the present embodiment has three cameras, the electrical device 10 may have less or more than three cameras. For example, the electrical device 10 may have two, four, five, and so on, cameras.

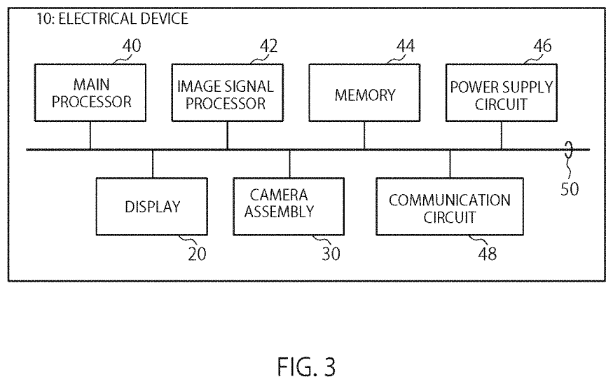

FIG. 3 illustrates a block diagram of the electrical device 10 according to the present embodiment. As shown in FIG. 3, in addition to the display 20 and the camera assembly 30, the electrical device 10 may include a main processor 40, an image signal processor 42, a memory 44, a power supply circuit 46 and a communication circuit 48. The display 20, the camera assembly 30, the main processor 40, the image signal processor 42, the memory 44, the power supply circuit 46 and the communication circuit 48 are connected with each other via a bus 50.

The main processor 40 executes one or more programs stored in the memory 44. The main processor 40 implements various applications and data processing of the electrical device 10 by executing the programs. The main processor 40 may be one or more computer processors. The main processor 40 is not limited to one CPU core, but it may have a plurality of CPU cores. The main processor 40 may be a main CPU of the electrical device 10, an image processing unit (IPU) or a digital signal processor (DSP) provided with the camera assembly 30.

The image signal processor 42 controls the camera assembly 30 and processes various kinds of image captured by the camera assembly 30. For example, the image signal processor 42 can execute a de-mosaic process, a noise reduction process, an auto exposure process, an auto focus process, an auto white balance process, a high dynamic range process and so on, to the image captured by the camera assembly 30.

In the present embodiment, the main processor 40 and the image signal processor 42 collaborate with each other to generate an image of the object captured by the camera assembly 30. That is, the main processor 40 and the image signal processor 42 are configured to capture the image of the object by the camera assembly 30 and execute various kinds of image processes to the captured image.

The memory 44 stores a program to be executed by the main processor 40 and various kinds of data. For example, data of the captured image are stored in the memory 44.

The memory 44 may include a high-speed RAM memory, and/or a non-volatile memory such as a flash memory and a magnetic disk memory. That is, the memory 44 may include a non-transitory computer readable medium in which the program is stored.

The power supply circuit 46 may have a battery such as a lithium-ion rechargeable battery, and a battery management unit (BMU) for managing the battery.

The communication circuit 48 is configured to receive and transmit data to communicate with base stations of the telecommunication network system, the Internet or other devices via wireless communication. The wireless communication may use any communication standards or protocols including, but not limited to, GSM (Global System for Mobile communication), CDMA (Code Division Multiple Access), LTE (Long Term Evolution), LTE-Advanced, and 5th generation (5G). The communication circuit 48 may include an antenna and an RF (radio frequency) circuit.

<Method of Removing Noise in an Image>

The method of removing noise in an image according to the embodiment of the present disclosure will be described. The method is an improvement on Non-Local Means filtering for denoising images with defect pixels. In that sense, it can be called a Defect Cared Non-Local Means (DCNLM) filtering.

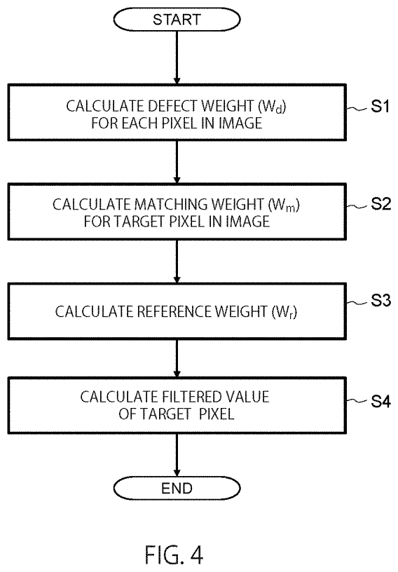

FIG. 4 shows a main flowchart of a noise removing process performed by the electrical device 10 according to the embodiment of the present disclosure.

In the present embodiment, the method of removing noise in an image is performed by, for example, the main processor 40. However, the main processor 40 may collaborate with the image signal processor 42 to perform the method.

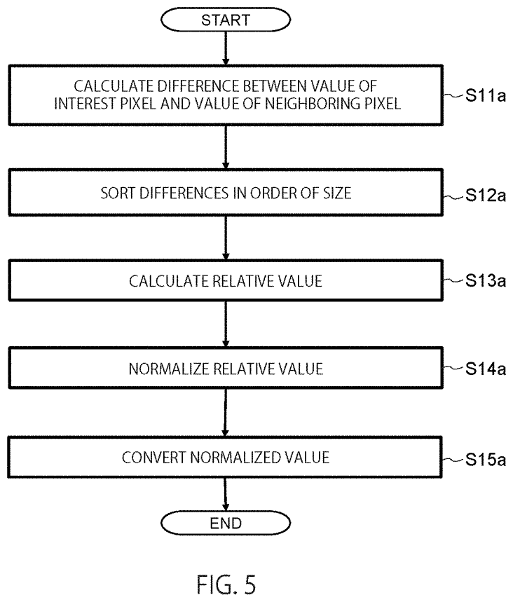

As shown in FIG. 4, the main processor 40 calculates a defect weight for each pixel in an image captured by the camera assembly 30 (Step S1). The defect weight (W_{d}) indicates a correlation between a pixel and its neighboring pixels. The defect weight may be in a range between 0 and 1 as described below. FIG. 5 shows a flowchart of one example for obtaining the defect weight.

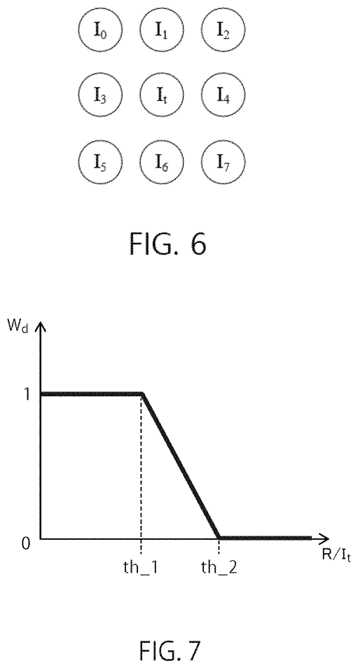

As shown in FIG. 5, the main processor 40 calculates a difference between a value of an interest pixel and a value of a neighboring pixel (Step S11a). In more detail, the main processor 40 calculates, for each pixel adjacent to the interest pixel, a difference between a value of the interest pixel and a value of a neighboring pixel. The adjacent pixels of the interest pixel are 8-neighbors or Moore neighborhoods (see FIG. 6).

The 8 differences (D₀ to D₇) are calculated by means of an equation (1),

Dᵢ=|Iₜ−Iᵢ| (1),

where Dᵢ (i=0, 1, 2 . . . 7) is the difference, Iₜ is a value of the interest pixel and Iᵢ is a value of the neighboring pixel.

Next, as shown in FIG. 5, the main processor 40 sorts the differences in order of size (Step S12a).

Next, as shown in FIG. 5, the main processor 40 calculates a relative value (Step S13a). Specifically, the main processor 40 sums up a predetermined number (e.g., N=2) of the smallest sorted differences to obtain a relative value (R).

Next, as shown in FIG. 5, the main processor 40 normalizes the relative value (Step S14a). In order to obtain a normalized value, the main processor 40 divides the relative value by the value of the interest pixel (i.e., R/Iₜ).

Next, as shown in FIG. 5, the main processor 40 converts the normalized value obtained in the step S14a to obtain the defect weight W_{d} (Step S15a). The normalized value is converted by using a predetermined function (e.g., a line function represented as a broken line graph). FIG. 7 shows an example of a graph of a line function for converting the normalized value (R/Iₜ). The line function has, as the defect weight W_{d}, a converted value of 1 if the normalized value is less than a threshold th_1 and has a converted value of 0 if the normalized value is more than a threshold th_2 which is greater than the threshold th_1. If the normalized value is between the threshold th_1 and the threshold th_2, the line function has an interpolated value between 0 and 1.

The function for converting the normalized value may be a function other than a line function, such as a Gaussian function. Alternatively, the normalized value may be converted by using a lookup table stored in the memory 44.

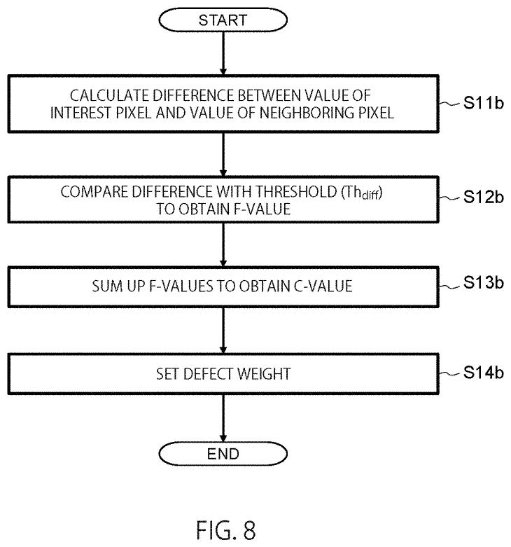

The method for calculating the defect weight is not limited to the above described method. FIG. 8 shows a flowchart of another example for obtaining the defect weight.

In this example, as shown in FIG. 8, the main processor 40 calculates a difference between a value of an interest pixel and a value of a neighboring pixel (Step S11b). This step is the same as the Step S11a described above. Similar to the step S11a, the 8 differences (D₀ to D₇) are obtained.

Next, as shown in FIG. 8, the main processor 40 compares the difference obtained in the step S11b and a first threshold. Specifically, the main processor 40 compares, for each pixel adjacent to the interest pixel, the difference with the first threshold (Th_{diff}). The main processor 40 sets an F-value to 1 if the difference is less than the first threshold and sets the F-value to 0 if the difference is equal to or more than the first threshold value. That is, the F-value (Fᵢ, i=0, 1, 2 . . . 7) for each neighboring pixel is set by means of an equation (2).

$${F}_{i} = \{ \begin{matrix}1 … ( {D}_{i} < {Th}_{diff} ) \\ 0 … ( {D}_{i} \geq {Th}_{diff} )\end{matrix} \qquad ( 2 )$$

Next, as shown in FIG. 8, the main processor 40 sums up the F-values (i.e., F₁, F₂ . . . F₇) to obtain a C-value (Step S13b). That is, the C-value is calculated by means of an equation (3).

$$C = {\sum }_{i = 0}^{7} {F}_{i} \qquad ( 3 )$$

Next, as shown in FIG. 8, the main processor 40 sets a defect weight W_{d} to 0 if the C-value is less than a second threshold (Th_{count}) and sets the defect weight W_{d} to 1 if the C-value is equal to or more than the second threshold. That is, the defect weight W_{d} is set by means of an equation (4).

$${W}_{d} = \{ \begin{matrix}0 … ( C < T {h}_{c o u n t} ) \\ 1 … ( C \geq {Th}_{c o u n t} )\end{matrix} \qquad ( 4 )$$

Returning to the main flowchart of FIG. 4, the processes following the calculating of the defect weight will be described.

As shown in FIG. 4, the main processor 40 calculates a matching weight for a target pixel in the image (Step S2). In more detail, a plurality of the matching weights are calculated for one target pixel. Each of the matching weights indicates a similarity between a target block centered on the target pixel and a reference block centered on a reference pixel located within a search range from the target pixel.

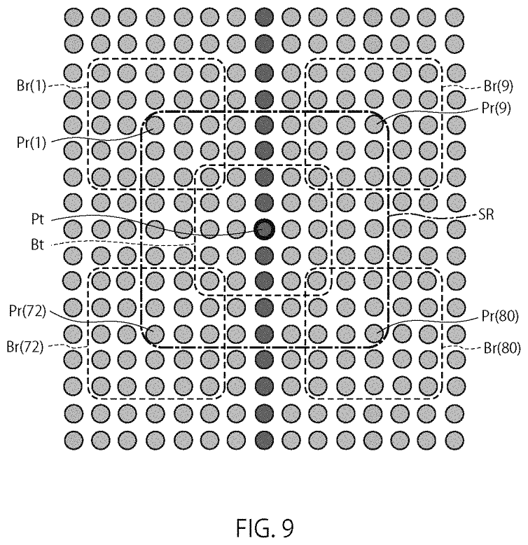

FIG. 9 shows an example of a target block Bt, a plurality of reference blocks Br(1), Br(2), . . . , Br(80) and a search range SR. As shown in FIG. 9, the size of the target block Bt is 5×5 pixels. The size of each of the reference blocks Br(1), Br(2), . . . , Br(80) is 5×5 pixels. The size of the search range SR is 9×9 pixels. There are 80 reference pixels Pr(1), Pr(2), . . . , Pr(80) in the search range SR for a target pixel Pt. In this case, 80 matching weights are calculated for the target pixel Pt.

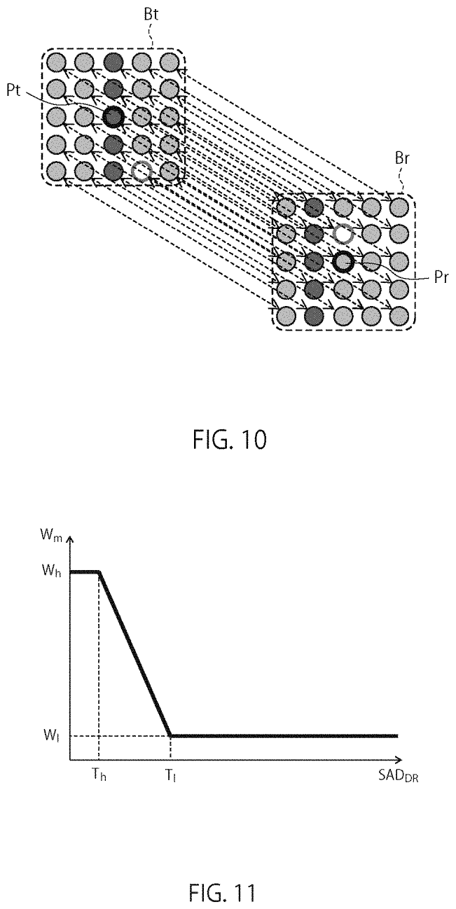

FIG. 10 shows an example of the target block Bt and one of the plurality of reference blocks Br. In the example, one defect pixel is indicated by a white circle in each of the target block and the reference block. As shown in FIG. 10, for a pair of a pixel in the target block Bt and a corresponding pixel in the reference block Br, a similarity between these pixels is calculated. The matching weight is calculated by summing up the similarity for each pair taking into account the defect weights in the target block and the reference block. That is, the matching weight Wm is calculated by means of equations (5) and (6),

$$S A {D}_{D R} = \frac{{\sum }_{i ∈ B l o c {k}_{target ,} j ∈ B l o c {k}_{r e f}} {W}_{d} ( i ) \times {W}_{d} ( j ) \times \vert I ( i ) - I ( j ) \vert}{{\sum }_{i ∈ B l o c {k}_{target ,} j ∈ B l o c {k}_{r e f}} {W}_{d} ( i ) \times {W}_{d} ( j )} \qquad ( 6 )$$

$${W}_{m} = f ( S A {D}_{D R} ) , \qquad ( 6 )$$

where SAD_{DR} is a Sum of Absolute Difference with Defect Respected, W_{d}(i) is the defect weight of a pixel i (i=1, 2, . . . , 25) in the target block Bt, W_{d}(j) is the defect weight of a pixel j (j=1, 2, . . . , 25) in the reference block Br, I(i) is a value of the pixel i, I(j) is a value of the pixel j, Wₘ is the matching weight and f is a conversion function for converting the SAD_{DR} to the matching weight.

It should be noted that the denominator on the right side of the equation (5) is for normalizing the numerator.

As is clear from the equation (5), the SAD_{DR} decreases as the similarity between the target block and the reference block increases.

SAD_{DR} may be calculated by another equation, such as an equation including a square of an absolute difference between I(i) and I(j), i.e., |I(i)−I(j)|².

The conversion function converts the SAD_{DR} to the matching weight Wm. For example, as shown in FIG. 11, the conversion function converts the SAD_{DR} to a value Wₕ when the SAD_{DR} is less than a threshold Tₕ and converts the SAD_{DR} to a value Wₗ when the SAD_{DR} is more than a threshold Tₗ. When the SAD_{DR} is between the threshold Tₕ and the threshold Tₗ, the conversion function converts the SAD_{DR} to an interpolated value between the value Wₕ and the value Wₗ. The value Wₕ is 1 and the value Wₗ is 0. But, the values Wₕ and Wₗ are not limited to these values. For example, the value Wₕ may be 0.9 and the value Wₗ may be 0.1. The thresholds Tₕ and Tₗ may be adjusted according to the characteristics of the image.

The conversion function may be a function other than the line function such as a Gaussian function. Alternatively, the SAD_{DR} may be converted by using a lookup table stored in the memory 44.

As described above, in the step S2, the matching weight Wₘ is calculated by means of the defect weight W_{d} obtained in the Step S1. Therefore, it is possible to avoid any problems which a defect pixel causes by taking into account the defect weight. That is, according to the present embodiment, even if there are one or more defect pixels in the target block and/or the reference blocks, a reasonable matching weight can be calculated.

Next, as shown in FIG. 4, the main processor 40 calculates a reference weight (Step S3). The reference weight is calculated for each reference pixel in the search range SR.

The reference weight is calculated based on the defect weight of the reference pixel and the matching weight between the reference block centered on the reference pixel and the target block. For example, the reference weight is calculated by multiplying the matching weight Wₘ by the defect weight W_{d} of the reference pixel. That is, the reference weight is given by an equation (7),

Wᵣ(j)=W_{d}(j)×Wₘ(j) (7),

where Wᵣ(j) is a reference weight between the target block and the reference block centered on the reference pixel j, W_{d}(j) is a defect weight for the reference pixel j and Wₘ(j) is the matching weight between the target block and the reference block centered on the reference pixel J.

In the example shown in FIG. 9, Wᵣ(1), Wᵣ(2), . . . , Wᵣ(80) are calculated in the step S3.

Next, as shown in FIG. 4, the main processor 40 calculates a filtered value (final value) of the target pixel (Step S4). The filtered value is calculated based on a value of the reference pixel in the search range and the matching weight between the target block and the reference block centered on the reference pixel. For example, the filtered value of the target pixel is calculated by means of an equation (8),

$${I}_{target} = \frac{{\sum }_{j ∈ Search range} I ( j ) \times {W}_{r} ( j )}{{\sum }_{j ∈ Search range} {W}_{r} ( j )} , \qquad ( 8 )$$

where I_{target} is the filtered value of the target pixel, I(j) is a value of the reference pixel j in the search range and Wᵣ(j) is the reference weight between the target block and the reference block centered on the reference pixel j.

It should be noted that the denominator on the right side of the equation (8) is for normalizing the numerator.

The above described steps S2 to S4 are performed for each target pixel in the image.

As mentioned, in the present embodiment, an unsuitable value due to a defect pixel etc., in a target block and/or a reference block is ignored or suppressed by taking into account the defect weight when a matching weight is calculated. That is, a value of the SAD_{DR} is calculated as the similarity between the target block and the reference block. As a result, according to the present embodiment, it is possible to perform appropriate Non-Local Means (NLM) filtering even if there is a defect pixel or a spike noise in the image.

In the case that the electrical device 10 is a smartphone or a tablet terminal, the camera assembly 30 usually does not have a shutter. If the camera assembly 30 has a shutter, a defect pixel of an image sensor can be found in advance by closing the shutter during the exposure environment, and thus a defect in an image can be corrected by the image sensor so that appropriate NLM filtering is performed. In contrast, according to the present disclosure, it is possible to perform appropriate NLM filtering even if the electrical device has a camera assembly without a shutter.

Further, in the preset embodiment, the reference weight Wᵣ is used to calculate the filtered value of the target pixel. Therefore, if a reference pixel is a defect pixel (i.e., the defect weight of the reference pixel is 0 or low), as is clear from the equation (8), the reference pixel is ignored or suppressed to calculate the filtered value.

Still further, according to the present disclosure, a value of the target pixel can be corrected since a filtered value is calculated based on a value of a reference pixel and a reference weight of the reference pixel as is clear from the equation (8).

Optionally, the reference weight calculating process (the step S3) may be omitted. In this case, the filtered value of the target pixel is calculated by means of an equation (9),

$${I}_{target} = \frac{{\sum }_{j ∈ Search range} I ( j ) \times {W}_{m} ( j )}{{\sum }_{j ∈ Search range} {W}_{m} ( j )} , \qquad ( 9 )$$

where I_{target} is the filtered value of the target pixel, I(j) is a value of the reference pixel j in the search range and Wₘ(j) is the matching weight between the target block and the reference block centered on the reference pixel j.

In the description of embodiments of the present disclosure, it is to be understood that terms such as “central”, “longitudinal”, “transverse”, “length”, “width”, “thickness”, “upper”, “lower”, “front”, “rear”, “back”, “left”, “right”, “vertical”, “horizontal”, “top”, “bottom”, “inner”, “outer”, “clockwise” and “counterclockwise” should be construed to refer to the orientation or the position as described or as shown in the drawings in discussion. These relative terms are only used to simplify the description of the present disclosure, and do not indicate or imply that the device or element referred to must have a particular orientation, or must be constructed or operated in a particular orientation. Thus, these terms cannot be constructed to limit the present disclosure.

In addition, terms such as “first” and “second” are used herein for purposes of description and are not intended to indicate or imply relative importance or significance or to imply the number of indicated technical features. Thus, a feature defined as “first” and “second” may comprise one or more of this feature. In the description of the present disclosure, “a plurality of” means “two or more than two”, unless otherwise specified.

In the description of embodiments of the present disclosure, unless specified or limited otherwise, the terms “mounted”, “connected”, “coupled” and the like are used broadly, and may be, for example, fixed connections, detachable connections, or integral connections; may also be mechanical or electrical connections; may also be direct connections or indirect connections via intervening structures; may also be inner communications of two elements which can be understood by those skilled in the art according to specific situations.

In the embodiments of the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are in contact via an additional feature formed therebetween. Furthermore, a first feature “on”, “above” or “on top of” a second feature may include an embodiment in which the first feature is orthogonally or obliquely “on”, “above” or “on top of” the second feature, or just means that the first feature is at a height higher than that of the second feature; while a first feature “below”, “under” or “on bottom of” a second feature may include an embodiment in which the first feature is orthogonally or obliquely “below”, “under” or “on bottom of” the second feature, or just means that the first feature is at a height lower than that of the second feature.

Various embodiments and examples are provided in the above description to implement different structures of the present disclosure. In order to simplify the present disclosure, certain elements and settings are described in the above. However, these elements and settings are only by way of example and are not intended to limit the present disclosure. In addition, reference numbers and/or reference letters may be repeated in different examples in the present disclosure. This repetition is for the purpose of simplification and clarity and does not refer to relations between different embodiments and/or settings. Furthermore, examples of different processes and materials are provided in the present disclosure. However, it would be appreciated by those skilled in the art that other processes and/or materials may also be applied.

Reference throughout this specification to “an embodiment”, “some embodiments”, “an exemplary embodiment”, “an example”, “a specific example” or “some examples” means that a particular feature, structure, material, or characteristics described in connection with the embodiment or example is included in at least one embodiment or example of the present disclosure. Thus, the appearances of the above phrases throughout this specification are not necessarily referring to the same embodiment or example of the present disclosure. Furthermore, the particular features, structures, materials, or characteristics may be combined in any suitable manner in one or more embodiments or examples.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which it should be understood by those skilled in the art that functions may be implemented in a sequence other than the sequences shown or discussed, including in a substantially identical sequence or in an opposite sequence.

The logic and/or step described in other manners herein or shown in the flow chart, for example, a particular sequence table of executable instructions for realizing the logical function, may be specifically achieved in any computer readable medium to be used by the instructions execution system, device or equipment (such as a system based on computers, a system comprising processors or other systems capable of obtaining instructions from the instructions execution system, device and equipment executing the instructions), or to be used in combination with the instructions execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instructions execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although embodiments of the present disclosure have been shown and described, it would be appreciated by those skilled in the art that the embodiments are explanatory and cannot be construed to limit the present disclosure, and changes, modifications, alternatives and variations can be made in the embodiments without departing from the scope of the present disclosure.

1. A method of removing noise in an image, comprising:
calculating, for each pixel in the image, a defect weight indicating a correlation between pixel and its neighboring pixels;
calculating, for a target pixel in the image, a matching weight indicating a similarity between a target block centered on the target pixel and a reference block centered on a reference pixel located within a search range from the target pixel, the matching weight being calculated by means of the defect weight; and
calculating a filtered value of the target pixel based on a value of the reference pixel and the matching weight between the target block and the reference block centered on said reference pixel.

2. The method according to claim 1, wherein the calculating of the defect weight comprises:
calculating, for each pixel adjacent to an interest pixel, a difference between a value of the interest pixel and a value of a neighboring pixel;
sorting the differences in order of size;
summing up a predetermined number of the smallest sorted differences to obtain a relative value;
normalizing the relative value by dividing it by the value of the interest pixel to obtain a normalized value; and
converting the normalized value to obtain the defect weight.

3. The method according to claim 2, wherein the normalized value is converted by using a predetermined function or a lookup table.

4. The method according to claim 1, wherein the calculating of the defect weight comprises:
calculating, for each pixel adjacent to an interest pixel, a difference between a value of the interest pixel and a value of a neighboring pixel;
comparing, for each pixel adjacent to the interest pixel, the difference with a first threshold, and setting an F-value to 0 if the difference is equal to or more than the first threshold value and setting the F-value to 1 if the difference is less than the first threshold;
summing up the F-values to obtain a C-value; and
setting the defect weight to 0 if the C-value is less than a second threshold and setting the defect weight to 1 if the C-value is equal to or more than the second threshold.

5. The method according to claim 1, wherein the defect weight is in a range between 0 and 1.

6. The method according to claim 1, wherein the matching weight is calculated by means of equations (1) and (2),
$$SA {D}_{D R} = \frac{{\sum }_{i ∈ B l o c {k}_{target ,} j ∈ B l o c {k}_{r e f}} {W}_{d} ( i ) \times {W}_{d} ( j ) \times \vert I ( i ) - I ( j ) \vert}{{\sum }_{i ∈ B l o c {k}_{target ,} j ∈ B l o c {k}_{r e f}} {W}_{d} ( i ) \times {W}_{d} ( j )} \qquad ( 1 )$$
$${W}_{m} = f ( S A {D}_{D R} ) , \qquad ( 2 )$$
where SAD_{DR} is a Sum of Absolute Difference with Defect Respected, W_{d}(i) is the defect weight of a pixel i (the i^{th} pixel) in the target block, W_{d}(j) is the defect weight of a pixel j (the j^{th} pixel) in the reference block, I(i) is a value of the pixel i, I(j) is a value of the pixel j, Wₘ is the matching weight and f is a conversion function.

7. The method according to claim 1, wherein the filtered value of the target pixel is calculated by means of an equation (3),
$${I}_{target} = \frac{{\sum }_{j ∈ S e arch range} I ( j ) \times {W}_{m} ( j )}{{\sum }_{j ∈ S e arch range} {W}_{m} ( j )} , \qquad ( 3 )$$
where I_{target} is the filtered value of the target pixel, I(j) is a value of the reference pixel j in the search range, and Wₘ(j) is the matching weight between the target block and the reference block centered on the reference pixel j.

8. The method according to claim 1, further comprising, after the calculating of the matching weight, calculating a reference weight based on the defect weight of the reference pixel and the matching weight,
wherein the filtered value of the target pixel is calculated by means of an equation (4),
$${I}_{target} = \frac{{\sum }_{j ∈ S e arch range} I ( j ) \times {W}_{r} ( j )}{{\sum }_{j ∈ S e arch range} {W}_{r} ( j )} , \qquad ( 4 )$$
where I_{target} is the filtered value of the target pixel, I(j) is a value of the reference pixel j in the search range and Wᵣ(j) is the reference weight between the target block and the reference block centered on the reference pixel j.

9. The method according to claim 8, wherein the reference weight is calculated by multiplying the matching weight by the defect weight of the reference pixel.

10. An electrical device for image processing, comprising:
a processor; and
a memory for storing instructions which, when executed by the processor, cause the processor to:
calculate, for each pixel in the image, a defect weight indicating a correlation between pixel and its neighboring pixels;
calculate, for a target pixel in the image, a matching weight indicating a similarity between a target block centered on the target pixel and a reference block centered on a reference pixel located within a search range from the target pixel, the matching weight being calculated by means of the defect weight; and
calculate a filtered value of the target pixel based on a value of the reference pixel and the matching weight between the target block and the reference block centered on said reference pixel.

11. The electrical device according to claim 10, further comprising a camera assembly without a shutter.

12. A non-transitory computer-readable storage medium storing a computer program which, when executed by a computer, causes the computer to:
calculate, for each pixel in the image, a defect weight indicating a correlation between pixel and its neighboring pixels;
calculate, for a target pixel in the image, a matching weight indicating a similarity between a target block centered on the target pixel and a reference block centered on a reference pixel located within a search range from the target pixel, the matching weight being calculated by means of the defect weight; and
calculate a filtered value of the target pixel based on a value of the reference pixel and the matching weight between the target block and the reference block centered on said reference pixel.

13. The electrical device according to claim 10, wherein the processor configured to calculate the defect weight is configured to:
calculate, for each pixel adjacent to an interest pixel, a difference between a value of the interest pixel and a value of a neighboring pixel;
sort the differences in order of size;
sum up a predetermined number of the smallest sorted differences to obtain a relative value;
normalize the relative value by dividing it by the value of the interest pixel to obtain a normalized value; and
convert the normalized value to obtain the defect weight.

14. The electrical device according to claim 13, wherein the normalized value is converted by using a predetermined function or a lookup table.

15. The electrical device according to claim 10, wherein the processor configured to calculate the defect weight is configured to:
calculate, for each pixel adjacent to an interest pixel, a difference between a value of the interest pixel and a value of a neighboring pixel;
compare, for each pixel adjacent to the interest pixel, the difference with a first threshold, and set an F-value to 0 if the difference is equal to or more than the first threshold value and set the F-value to 1 if the difference is less than the first threshold;
sum up the F-values to obtain a C-value; and
set the defect weight to 0 if the C-value is less than a second threshold and set the defect weight to 1 if the C-value is equal to or more than the second threshold.

16. The electrical device according to claim 10, wherein the defect weight is in a range between 0 and 1.

17. The electrical device according to claim 10, wherein the matching weight is calculated by means of equations (1) and (2),
$$SA {D}_{D R} = \frac{{\sum }_{i ∈ B l o c {k}_{target ,} j ∈ B l o c {k}_{r e f}} {W}_{d} ( i ) \times {W}_{d} ( j ) \times \vert I ( i ) - I ( j ) \vert}{{\sum }_{i ∈ B l o c {k}_{target ,} j ∈ B l o c {k}_{r e f}} {W}_{d} ( i ) \times {W}_{d} ( j )} \qquad ( 1 )$$
$${W}_{m} = f ( S A {D}_{D R} ) , \qquad ( 2 )$$
where SAD_{DR} is a Sum of Absolute Difference with Defect Respected, W_{d}(i) is the defect weight of a pixel i (the i^{th} pixel) in the target block, W_{d}(j) is the defect weight of a pixel j (the j^{th} pixel) in the reference block, I(i) is a value of the pixel i, I(j) is a value of the pixel j, Wₘ is the matching weight and f is a conversion function.

18. The electrical device according to claim 10, wherein the filtered value of the target pixel is calculated by means of an equation (3),
$${I}_{target} = \frac{{\sum }_{j ∈ S e arch range} I ( j ) \times {W}_{m} ( j )}{{\sum }_{j ∈ S e arch range} {W}_{m} ( j )} , \qquad ( 3 )$$
where I_{target} is the filtered value of the target pixel, I(j) is a value of the reference pixel j in the search range, and Wₘ(j) is the matching weight between the target block and the reference block centered on the reference pixel j.

19. The electrical device according to claim 10, wherein the processor is further configured to: after the calculating of the matching weight, calculate a reference weight based on the defect weight of the reference pixel and the matching weight,
wherein the filtered value of the target pixel is calculated by means of an equation
$${I}_{target} = \frac{{\sum }_{j ∈ S e arch range} I ( j ) \times {W}_{r} ( j )}{{\sum }_{j ∈ S e arch range} {W}_{r} ( j )} , \qquad ( 4 )$$
where I_{target} is the filtered value of the target pixel, I(j) is a value of the reference pixel j in the search range and Wᵣ(j) is the reference weight between the target block and the reference block centered on the reference pixel j.

20. The electrical device according to claim 19, wherein the reference weight is calculated by multiplying the matching weight by the defect weight of the reference pixel.
